(19) United States
(12) Patent Application Publication
(10) Pub. No.: US 2003/0090699 A1
(43) Pub. Date: May 15, 2003

(54) Method and apparatus for a voucher security module in a gaming printer

(76) Inventors: Eric J. Meyerhofer, Oceanside, CA (US); Oleg V. Dymovsky, Los Angeles, CA (US); Mark S. Meyerhofer, La Canada, CA (US)

Correspondence Address: CHRISTIE, PARKER & HALE, LLP, P.O. BOX 7068, PASADENA, CA, 91109-7068, US

(21) Appl. No.: 10/259,207

(22) Filed: Sep. 27, 2002

Related U.S. Application Data
(60) Provisional application No. 60/326,080, filed on Sep. 28, 2001.

(51) Int. Cl. B41F 1/00; G06F 15/00

(52) U.S. Cl. 358/1.14

(57) ABSTRACT

A method and apparatus for providing a gaming printer with anti-tamper features. A removably attached voucher security module is provided for a gaming printer. The voucher security module is operable by the gaming printer to prevent interference with a voucher printing and validation procedure. The voucher security module is further operable by the gaming printer to retrieve a voucher that fails a validation process for voiding and to hold the voided voucher for retrieval by a human attendant.

### CROSS-REFERENCE TO RELATED APPLICATION

This application claims the benefit of U.S. Provisional Patent Application No. 60/326,080 filed Sep. 28, 2001 which is hereby incorporated by reference as if set forth in full herein.

### BACKGROUND OF THE INVENTION

This invention relates generally to gaming printers and more specifically to gaming printers with anti-tamper features.

The gaming machine manufacturing industry provides a variety of gaming machines for the amusement of gaming machine players. An exemplary gaming machine is a slot machine. A slot machine is an electromechanical game wherein chance or the skill of a player determines the outcome of the game. Slot machines are usually found in casinos or other more informal gaming establishments.

The gaming machine manufacturers have introduced the use of a gaming printer resident in a gaming machine or for a bank of gaming machines that allows the printing of a voucher for a player's winnings when the player cashes out. The voucher can either be redeemed with a cashier or redeemed by inserting the voucher into the same or another gaming machine for playing credit, as if the voucher were money. The gaming printer's role, therefore, is to print out winnings thereby avoiding the need for the gaming machine to dispense coins with each pay-out or jackpot won. For this application, both dot impact printers and thermal printers are being employed. Dot impact printers, also known as impact printers, are printers that make an image by striking an inked ribbon overlaid on plain paper with a small pin that hammers the ink onto the paper to make a small dot. Impact printers, by their electromechanical nature, have a number of moving parts and make a characteristic grinding sound, such as the noise made by all older receipt printers. A thermal printer is a printer where paper with a heat sensitive side is imaged using a print head which applies heat in tiny dots (typically 1/200th of an inch in size) in order to turn an area black. In this manner, all images are created by a series of tiny black dots. A widely known example of a thermal printer is the original fax machine.

The gaming printer may be controlled by a Slot Machine Interface Board (SMIB) which is a controller board for a gaming machine resident within a chassis of the gaming machine. A gaming printer is controlled by commands sent from a host controller board such as a SMIB, or another host controller board upstream of the gaming machine in order to print vouchers.

Anytime there an electromechanical device such as a gaming printer, there is a finite chance for an equipment failure that leaves a desired operation unaccomplished. For a thermal printer used as a gaming printer, such a failure can occur for a number of reasons: (i) the printer experiences a hardware failure; (ii) a residue or heat transfer failure which prevents a proper image from developing on the thermal paper voucher; or (iii) a failure in the paper coating process at the factory so that there is a drop out on the printed image.

Any of the itemized failures above will prevent the voucher from printing completely. Since a voucher, sometimes with a value of $1,000 or more is being dispensed (as opposed to real currency), it is very important that the voucher delivery and redemption process is highly reliable to allay a player's fear about the handling of their “money”. After a voucher is printed, the voucher can be redeemed with a cashier or the voucher can be redeemed through a gaming machine's bill acceptor. A bill acceptor is a device which automatically accepts paper currency by scanning the paper currency and saving the paper currency within the gaming machine. A coin change machine usually has such a device on it, and more recently, so do most gaming machines. The standard vouchers for this application usually bear a barcode down the center of the voucher so that the voucher can be read automatically by the bill acceptor.

### SUMMARY OF THE INVENTION

A method is provided of securing a voucher during a printing process by a gaming printer a voucher security module is coupled to the gaming printer and receives a voucher as printed by the gaming printer. The voucher security module holds the voucher until the voucher security module receives a voucher presentation signal from the gaming printer. In response to the voucher presentation signal, the voucher security module presents the voucher to a player whereby the player is prevented from obtaining the voucher until the gaming printer has completed printing the voucher.

In another aspect of the invention, the gaming printer determines the validity of the voucher and generates the voucher presentation signal only if the voucher is determined to be valid.

In another aspect of the invention, the voucher is secured by the voucher security module as the gaming printer validates the voucher. If the gaming printer determines that the voucher is invalid, the gaming printer transmits a voucher retraction signal to the voucher security module. In response to the voucher retraction signal, the voucher security module retracts the voucher into the gaming printer whereby a player is prevented from obtaining the invalid voucher.

In another aspect of the invention, the gaming printer voids the retracted and invalid voucher.

In another aspect of the invention, an invalid voucher is held within the voucher security module if the gaming printer determines that the voucher is invalid whereby a player is prevented from obtaining the invalid voucher.

In another aspect of the invention, an apparatus is provided for securing a voucher by a gaming printer. The apparatus includes means for generating a voucher presentation signal and a voucher security means coupled to the gaming printer for receiving the voucher and for presenting the voucher to a player in response to the voucher presentation signal whereby a player is prevented from obtaining the voucher until the gaming printer has completed printing the voucher.

In another aspect of the invention, the means for generating a voucher presentation signal further includes means for determining if the voucher is valid and means for generating the voucher presentation signal if the voucher is determined to be valid.

In another aspect of the invention, an apparatus for securing a voucher by a gaming printer is provided having a means for determining if the voucher is valid and means for generating a voucher retraction signal if the voucher is invalid. The apparatus further includes a voucher security means coupled to the gaming printer for receiving the voucher and for retracting the voucher into the gaming printer in response to the voucher retraction signal whereby a player is prevented from obtaining the voucher. In another aspect of the invention, the apparatus further includes means for voiding the retracted invalid voucher.

In another aspect of the invention, an apparatus for securing a voucher by a gaming printer is provided having a means for determining if the voucher is valid and a voucher security means coupled to the gaming printer for receiving and holding the voucher if the voucher is invalid whereby a player is prevented from obtaining the voucher.

In another aspect of the invention, a voucher security module is provided for attachment to a gaming printer. The voucher security module includes a housing removably attached to the gaming printer. A voucher guide is secured within the housing with the voucher guide having a path length substantially the same as a length of a voucher printed by the gaming printer. A a roller assembly secured within the housing and substantially aligned with the voucher guide is coupled to a drive motor secured within the housing whereby a voucher printed by the gaming printer is received by the voucher security module and held within the housing.

In another aspect of the invention, the voucher security module housing further includes a removable cover for retrieval of an invalid voucher held within the voucher security module housing.

### BRIEF DESCRIPTION OF THE DRAWINGS

These and other features, aspects, and advantages of the present invention will become better understood with regard to the following description, appended claims, and accompanying drawings where:

FIG. 1 is an illustration of a validation character string validation system in accordance with an exemplary embodiment of the present invention;

FIG. 2 is an illustration of a voucher in accordance with an exemplary embodiment of the present invention;

FIG. 3 is an illustration of a gaming printer in accordance with an exemplary embodiment of the present invention;

FIG. 4 is an illustration of a gaming printer incorporated into a gaming machine management system in accordance with an exemplary embodiment of the present invention;

FIG. 5 is a process flow diagram of a validation character string validation process in accordance with an exemplary embodiment of the present invention;

FIG. 6 is a process flow diagram of a validation character string versus barcode validation process in accordance with an exemplary embodiment of the present invention;

FIG. 7 is an illustration of a Voucher Security Module (VSM) attached to a gaming printer in accordance with an exemplary embodiment of the present invention;

FIG. 8 is an illustration of the internal features of a Voucher Security Module (VSM) in accordance with an exemplary embodiment of the present invention; and

FIG. 9 is a process flow diagram of a voucher security process in accordance with an exemplary embodiment of the present invention.

### DETAILED DESCRIPTION OF THE INVENTION

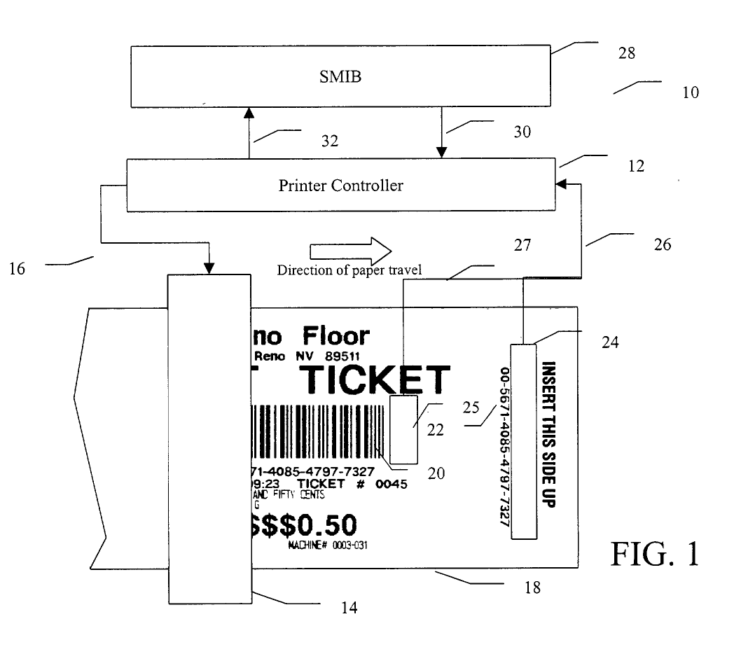

FIG. 1 is an illustration of an exemplary validation character string validation system in accordance with the present invention. A validation character string validation system 10 includes a printer controller 12 operatively coupled to a print head 14 and a voucher scanning device 24. The printer controller uses the print head to print a voucher 18 including a validation character string 22. As the voucher is being printed, the printer controller uses the voucher scanning device to scan the previously printed validation character string. If the printer controller determines that the scanned validation character string has an error, then the printer controller voids or retrieves the voucher.

In slightly more detail, the printer controller transmits print head control signals 16 to the print head. The print head control signals include voucher printing instructions for generation of the voucher by the print head. The print head uses the voucher printer instructions to print the voucher including a barcode 20 and the validation character string.

In one embodiment of a voucher in accordance with the present invention, the barcode includes an encoded validation character string. In another embodiment of a voucher in accordance with the present invention, the barcode is an encoded cashout value for the voucher and the validation character string is a separate character string or number used to validate the voucher.

The voucher scanning device scans the voucher as the voucher is being printed by the print head. In one embodiment of a voucher scanning device in accordance with the present invention, the voucher scanning device is a Charged-Coupled Device (CCD) optical scanner. The voucher scanning device transmits voucher scan signals 26 to the printer controller. In one embodiment of a voucher scanning device in accordance with the present invention, the voucher scan signals are unprocessed and the printer controller uses an optical character recognition (OCR) process to generate a scanned validation character string from the voucher scan signals. In another embodiment of a voucher scanning device in accordance with the present invention, the voucher scanning device includes an OCR process and the voucher scan signals include the recognized characters of the scanned validation character string.

In one voucher scanning device in accordance with an exemplary embodiment of the present invention, the voucher scanning device further includes a barcode scanner 25 for reading the barcode. The barcode scanner transmits scanned barcode signals 27 to the printer controller as the barcode scanner reads the printed barcode.

In one embodiment of a validation character string validation system in accordance with the present invention, a GMIB 28 is operably coupled to the printer controller. The printer controller receives printer control instructions 30 from the GMIB. The printer control instructions include the validation character string to be printed by the printer controller on the voucher. The printer controller uses the voucher scan signals, or the barcode signals, or both the voucher scan signals and the barcode signals to generate voucher validation signals 32 indicating whether or not the voucher has been validated. The printer controller transmits the voucher validation signals to the GMIB. The GMIB uses the voucher validation signals to determine if the voucher was correctly printed.

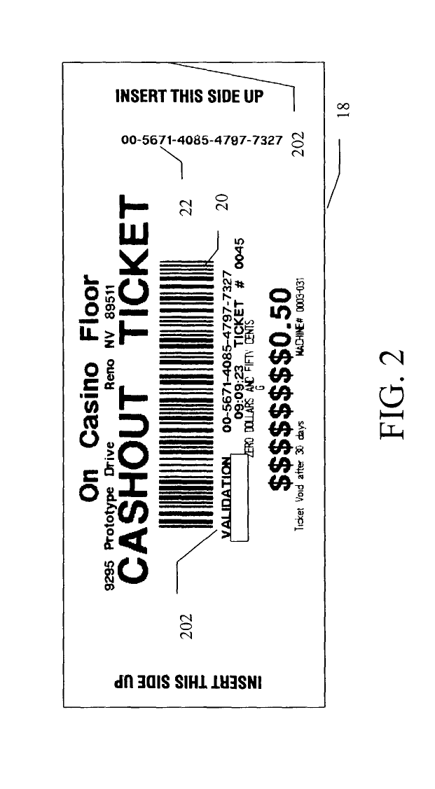

FIG. 2 is an illustration of an exemplary voucher in accordance with the present invention. Validation character strings may appear in a plurality of locations on a voucher and in a plurality of orientations. In one embodiment of a voucher, a validation character string 22 is printed near and substantially parallel to a leading edge 200 of the voucher. In another embodiment of a voucher, a validation character string 202 is located near and substantially parallel to a barcode 20. In another embodiment of a voucher, the voucher includes a single validation character string in a plurality of locations and a plurality of orientations.

The validation character string may be any sequence of human readable characters. In one embodiment of a validation character string, the validation character string includes numeric characters with interspersed spaces and dashes. In another embodiment of a validation character string, the validation character string includes alphanumeric characters.

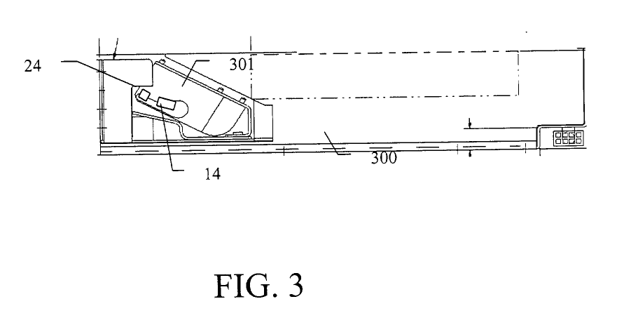

FIG. 3 is an illustration of an exemplary gaming printer including an exemplary validation character string validation system in accordance with the present invention. A gaming printer 300 includes a printing mechanism 301. The printing mechanism includes a print head 14 for printing vouchers and a voucher scanning device 24 for scanning a validation character string. In one embodiment of a validation character string validation system in accordance with the present invention, the print head and voucher scanning device are physically located such that the voucher scanning device can scan the voucher for the validation character string and a printer controller can finish a validation process of the validation character string before the print head has finished printing the voucher. In another embodiment of a validation character string validation system, the printer can invalidate the voucher before the voucher leaves the printer mechanism. In another embodiment of a validation character string validation system, the printer can retrieve a voucher so that a player cannot obtain the voucher if the voucher fails the validation process.

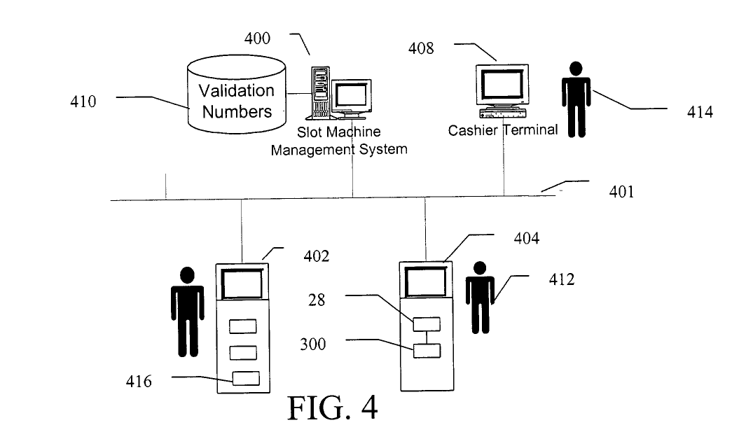

FIG. 4 is an illustration of an exemplary gaming printer incorporated into an exemplary gaming machine management system in accordance with the present invention. A gaming machine management system 400, such as a slot machine management system, is operably coupled to a plurality of gaming machines 402, 404, by a communications network 405 adapted for communications using a variety of protocols. The gaming machine management system is further operably coupled to a cashier's terminal 408. In operation, a player 412 plays the gaming machine and requests a cashout voucher (not shown). The gaming machine uses a gaming printer 300 to print a cashout voucher including a validation character string. The player takes the voucher to a cashier 414. The cashier uses the cashier terminal to enter the validation character sting included in the voucher into the gaming machine management system. The gaming machine management system validates the voucher for the cashier. If the gaming machine management system validates the voucher using the validation character string, the cashier pays the player the cashout value of the voucher.

In one embodiment of a gaming machine management system, the gaming machine management system is operably coupled to a gaming machine via a GMIB 28. The GMIB receives gaming machine management system signals transmitted by the gaming machine management system for management of the functions of a gaming machine. Additionally, the GMIB transmits gaming machine status signals to the gaming machine management system. For example, the GMIB receives voucher validation signals generated by the previously described voucher validation process as implemented within the gaming printer. If a voucher fails the validation process, the validation character string is transmitted to the gaming machine management system for further processing such as alerting casino personnel.

In one embodiment of a gaming machine management system, the validation character string represents an account identifier generated by the gaming machine management system for cashout transactions. The validation character string is associated with an account wherein a monetary amount equal to the value of a voucher's cashout value is stored. In this embodiment, the validation character string is used by the cashier to access the account for a transaction such as cashing the voucher for a player. Additionally, the player may use the voucher in another gaming machine's bill acceptor 410. When the voucher is cashed by the player, or the voucher is used in another gaming machine's bill acceptor 416, the voucher account is emptied and deleted by the gaming machine management system.

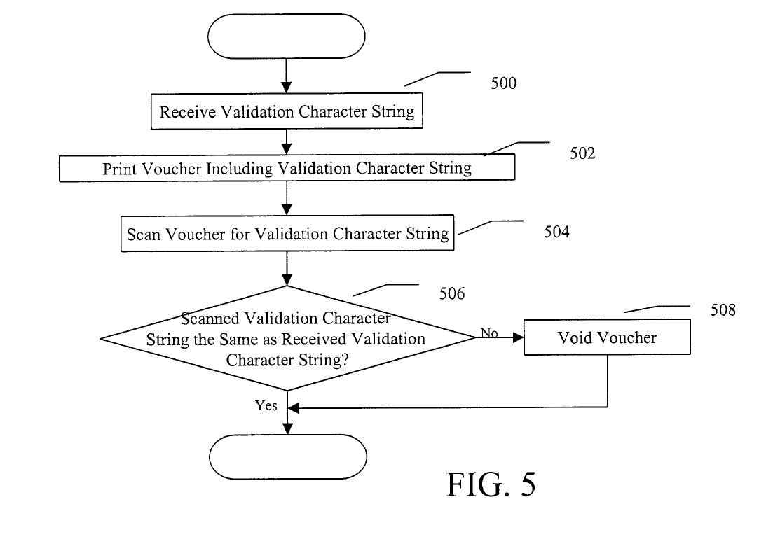

FIG. 5 is a process flow diagram of a validation character string validation process in accordance with the present invention. A printer controller receives 500 a validation character string. The printer controller prints 502 a voucher including the received validation character string. The printer controller does so by using the received validation character string to generate print head control signals. The printer controller transmits the print head control signals to a print head. The print head receives the print head control signals and uses them to print a voucher including the validation character string. The printer controller scans 504 the voucher for a scanned validation character string as the print head is printing the voucher using a voucher scanning device. The voucher scanning device generates voucher scan signals including the scanned validation character string by scanning the voucher as the voucher is being printed. The printer controller receives the voucher scan signals including the scanned validation character string.

In one embodiment of a validation character string validation process, the printer controller generates a scanned validation character string using the voucher scan signals in an OCR process. In another embodiment of a validation character string validation process, the voucher scan signals include a scanned validation character string generated in an OCR process by the voucher scanning device.

The printer controller compares the scanned validation character string and the received validation character string to validate 506 the scanned validation character string. If the validation process fails, the printer controller voids 508 the voucher.

In an embodiment of a validation character string validation process, the printer controller receives the validation character string to be printed from a GMIB. In another embodiment of a validation character string validation process, the printer controller receives the validation character string to be printed from a gaming machine management system.

Referring again to FIG. 2, a voucher may include a barcode 20 encoding the same information as the previously described validation character string 22. In another validation process in accordance with an embodiment of the present invention, the barcode is scanned along with the validation character string after printing and the barcode is compared to the validation character string. For a valid voucher, a character string encoded in the barcode and the validation character string are the same.

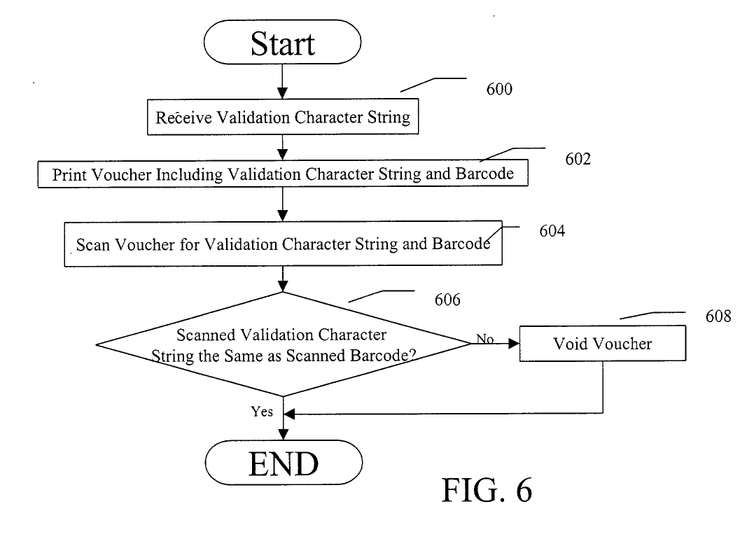

FIG. 6 is a process flow diagram of a validation character string versus barcode validation process in accordance with an exemplary embodiment of the present invention. A printer controller receives 600 a validation character string. The printer controller prints 602 a voucher including the received validation character string and a barcode encoding the same information as contained in the validation character string. The printer controller does so by using the received validation character string to generate print head control signals for both the validation character string and the barcode. The printer controller transmits the print head control signals to a print head. The print head receives the print head control signals and uses them to print a voucher including the validation character string and the barcode.

The printer controller scans 604 the voucher for a scanned validation character string and a scanned barcode as the print head is printing the voucher. The printer controller scans the voucher using a voucher scanning device. The voucher scanning device generates voucher scan signals including the scanned validation character string and the barcode by scanning the voucher as the voucher is being printed. The printer controller receives the voucher scan signals including the scanned validation character string and the scanned barcode.

In one embodiment of a validation character string validation process, the printer controller generates a scanned validation character string using the voucher scan signals in an OCR process. In another embodiment of a validation character string validation process, the voucher scan signals include a scanned validation character string generated in an OCR process by the voucher scanning device.

The printer controller compares the scanned validation character string and the scanned barcode to validate 606 that the information included in the scanned validation character string is comparable to the information included in the scanned barcode. If the validation process fails, the printer controller voids 608 the voucher.

Referring again to FIG. 3, a gaming printer 300 is installed inside of a gaming machine and is operably coupled to an SMIB as previously described. Revisiting the possible gaming printer errors as described above, a hardware failure of the gaming printer can be detected by communications with the SMIB, and thus an attendant can be alerted ahead of the pay out of the voucher. Previously described failure items (ii) and (iii) are modes which prevent a full image on the voucher and cannot be detected by the SMIB or the gaming printer. Such a printing error leaves a trace in the gaming machine record indicating that a complete and proper pay out has been made. Since this is obviously an undesirable condition, a reading of the voucher immediately after printing is used to validate proper operation of the printer as described in FIG. 5 and FIG. 6 above.

The addition of read after print validation to the printer drives a new requirement for the gaming printer: a player anxiously awaiting their voucher should not be allowed to pull on or in any way interfere with the voucher while it is being printed and validated. If not prevented, the act of pulling on the voucher may cause a failure in the print/validation process. This in turn may lead to the need to void the voucher. In order to void the voucher, the gaming printer may retract the voucher and overprint the voucher or at least hold the voucher retained until an attendant is available to service the situation. The problem is that the printer cannot retract the voucher if the player continues to hold or pull on the voucher, as a tug of war results with the gaming printer inevitably losing.

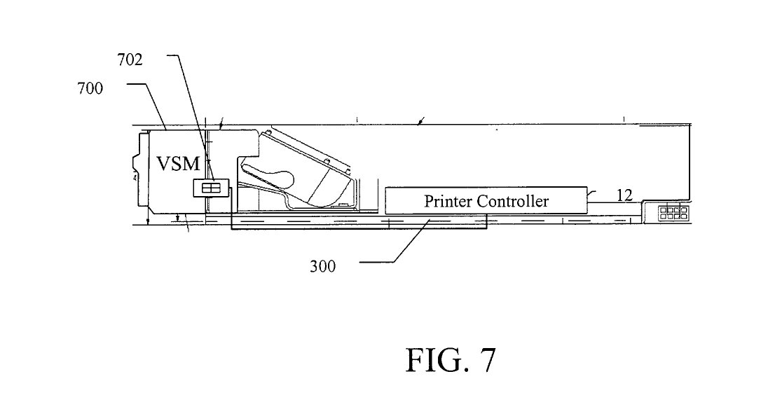

FIG. 7 is an illustration of a Voucher Security Module (VSM) in accordance with an exemplary embodiment of the present invention. A VSM 700 is removably attached as a separate fixture to the front of a previously described gaming printer 300. Additionally, the VSM is electrically coupled to previously described printer controller 12 via an electrical connector 702. The VSM is attached to the gaming printer such that vouchers printed by the gaming printer are received into the VSM.

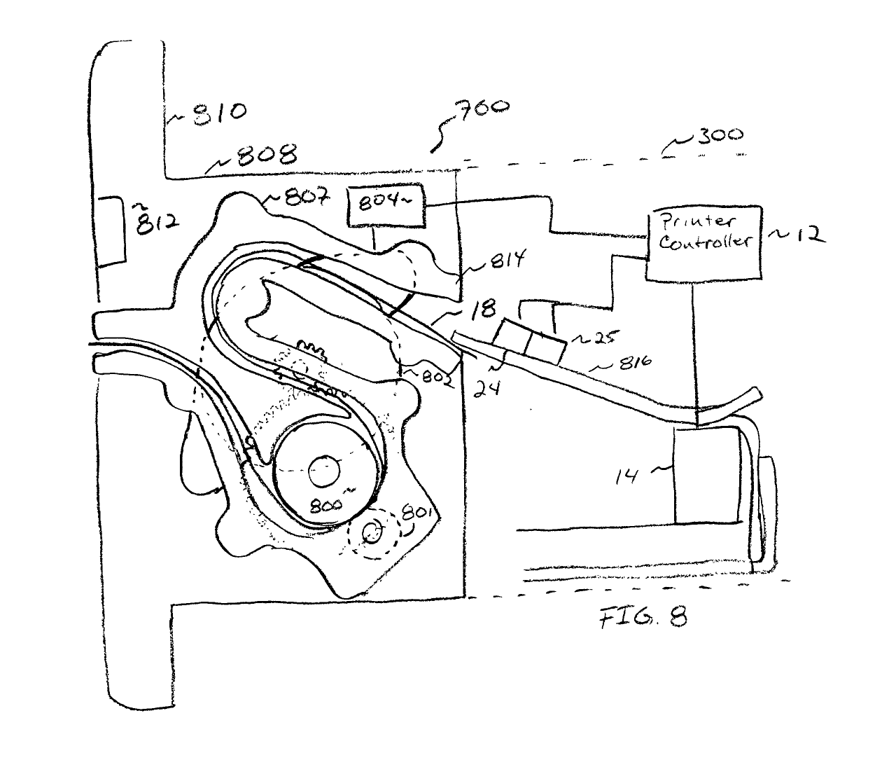

FIG. 8 is an illustration of the internal components of a VSM in accordance with an exemplary embodiment of the present invention. A VSM 700 includes housing 808 holding a roller assembly having a driven roller 800 and a friction roller 801. The driven roller is mechanically coupled to, and driven by, an electric drive motor 802 secured to the housing. The roller assembly is substantially aligned with a voucher guide 807 such that a voucher 18 may pinched between the drive and friction roller and driven through the voucher guide by the roller assembly. The VSM housing is coupled to a gaming printer 300 with an entry portion 814 of the voucher guide aligned with a paper guide 816 included in the gaming printer such that a voucher 18 ejected from the gaming printer is immediately taken into the voucher guide.

The drive motor is electrically coupled to, and controlled by, a VSM controller module 804. The VSM controller module is electrically coupled to printer controller 12 included in gaming printer 300. The printer controller may also be coupled to a barcode scanner 25 and a voucher scanning device 24 for reading a barcode or validation string printed on the voucher by the printer controller using printer head 14. The VSM's drive motor may be driven in either a forward direction or a reverse direction by the printer controller by generating and transmitting VSM control signals to the VSM controller module. In response, the VSM controller module uses the VSM control signals to generate signals to control the drive motor's operations. Driving the drive motor in a forward direction causes a voucher 18 to be taken into the VSM from the gaming printer and circuitously routed through a voucher guide 807 secured to the VSM housing. Driving the drive motor in the reverse direction causes the voucher to be retracted back through the voucher guide and back into the gaming printer for further printing operations, such as voiding, or storage.

In one embodiment of a VSM in accordance with an exemplary embodiment of the present invention, housing 808 includes a removable or openable cover 810. The cover may be located in a front portion of the housing as shown or may be located in a top, bottom, or side portion of the VSM housing. An attendant uses the cover to open the housing of the VSM in order to remove a voucher that is being held inside of the VSM. The cover may include a lock 812 for locking the cover in a closed position so that a player may not open the cover of the housing of the VSM and tamper with a voucher being held by the VSM.

In one embodiment of a VSM in accordance with an exemplary embodiment of the present invention, the path length of the voucher guide substantially the same as the length of a voucher. In this configuration, the circuitous route is sufficiently long enough that the voucher is not presented to a player until after the previously described printing and/or validation processes are finished. In this way, the player cannot take the voucher out of the VSM, and thus the gaming printer, before the printer controller has had a chance to print and validate the voucher.

Once the printer controller prints and validates the voucher, the printer controller can either: (1) transmit voucher presentation signals to the VSM whereby the VSM ejects the voucher so that the player can take the voucher from the VSM; or (2) transmit voucher retraction signals to the VSM whereby the VSM feeds the voucher back into the gaming printer for further processing; (3) stop the VSM from either ejecting the voucher or retracting the voucher by turning off the drive motor thus holding the voucher within the VSM.

In one mode of operation, the printer controller uses the VSM to prevent a player from accessing the voucher and interfering with the voucher printing and validation process. In another mode of operation, the printer controller uses the VSM to hold the voucher securely for attendant clearance in the event of a failed validation scan. In another mode of operation, the printer controller uses the VSM to retract the voucher for overprint or other voiding methods if the voucher fails the validation process. If the printer controller determines that the voucher is valid during the validation process, the printer controller uses the VSM to eject the voucher from the gaming machine for delivery to the player.

In one embodiment of a VSM in accordance an exemplary embodiment of the present invention, the VSM is removably attached to the gaming printer face by the use of snap buttons or quick activation latches. In this way, the VSM may be a treated as a separate fixture/product attached externally to the gaming printer and product flexibility is achieved. A casino may order a gaming machine with a standard gaming printer, and at a later date upgrade to voucher validation with a minimum of effort. Another advantage of a removably attached VSM is its ability to quickly disconnect from the printer in the event of a servicing need, allowing a VSM swap and the ability of the gaming machine to return to service in a short period of time.

In one embodiment of a VSM in accordance an exemplary embodiment of the present invention, the VSM does not include a VSM control module. Instead, the drive motor is directly coupled to the printer controller and the printer controller generates drive motor control signals for forwarding, holding, and reversing operations.

In one embodiment of a VSM in accordance with present invention, the VSM includes previously described barcode scanner 25 and voucher scanning device 24. In this embodiment, the voucher is scanned and validated as it enters the VSM rather than as the voucher leaves the gaming printer.

In another embodiment of a VSM in accordance with present invention, the VSM includes one or more voucher validation devices such as the previously described barcode scanner or the previously described voucher scanning device. Furthermore, the VSM control module control includes logic for using the previously described voucher scan signals, or the barcode signals, or both the voucher scan signals and the barcode signals to generate the previously described voucher validation signals. To validate a voucher, the VSM receives the validation character string from the printer controller or the barcode information, or both, and compares the received information with the scanned information to determine if the voucher is valid. The VSM control module then transmits to the printer controller the voucher validation signals for further processing.

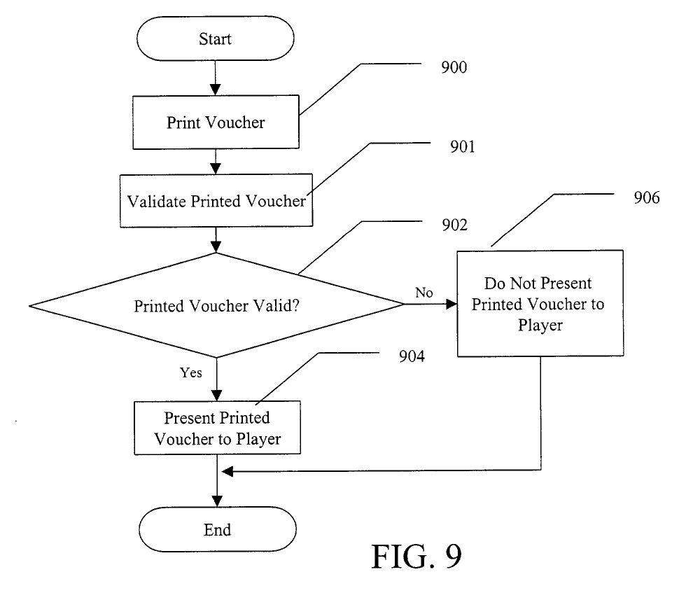

FIG. 9 is a process flow diagram of a voucher security process in accordance with an exemplary embodiment of the present invention. In operation, the printer controller prints (900) and validates (901) a voucher and the VSM stores the voucher until the printer controller determines (902) if the voucher is valid and should be presented to the player. For a typical voucher, this determination includes scanning a barcode or a validation string printed on the voucher during the printing process as previously described. The physical size of the gaming printer is such that the printing and validation process results in the voucher being fully ejected from the gaming printer by the time the validation process is complete. The gaming printer ejects the voucher into the VSM where the voucher is held until the printer controller determines the validity of the voucher. If the printer controller determines that the voucher is valid, the printer controller transmits voucher presentation signals to the VSM and the VSM responds to the voucher presentation signals by presenting (904) the voucher to the player through ejection of the voucher. If the printer controller determines that the voucher was improperly printed, then the printer controller may transmit voucher retraction signals to the VSM whereby the invalid voucher is retracted (906) back into the printer for over printing to void the invalid voucher.

In another voucher security process in accordance with an exemplary embodiment of the present invention, the printer controller may hold an invalid voucher in the VSM or the gaming printer until an attendant can come and retrieve the invalid voucher.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A method of securing a voucher during a printing process by a gaming printer, comprising:
providing a voucher security module coupled to the gaming printer;
receiving by the voucher security module a voucher printed by the gaming printer;
receiving by the voucher security module a voucher presentation signal from the gaming printer; and
presenting to a player the voucher by the voucher security module in response to the voucher presentation signal whereby the player is prevented from obtaining the voucher until the gaming printer has completed printing the voucher.

2. The method of claim 1, further comprising:
determining the validity of the voucher by the gaming printer; and
generating the voucher presentation signal by the gaming printer if the voucher is determined to be valid.

3. A method of securing a voucher during a printing and validation process by a gaming printer, comprising:
providing a voucher security module coupled to the gaming printer;
receiving by the voucher security module a voucher printed by the gaming printer;
receiving by the voucher security module a voucher retraction signal transmitted by the gaming printer; and
retracting the voucher by the voucher security module into the gaming printer in response to the voucher retraction signal whereby a player is prevented from obtaining the voucher.

4. The method of claim 3, further comprising:
determining the validity of the voucher by the gaming printer; and
generating the voucher retraction signal by the gaming printer if the voucher is determined to be invalid.

5. The method of claim 3, further comprising voiding the voucher by the gaming printer.

6. A method of securing a voucher during a printing and validation process by a gaming printer, comprising:
providing a voucher security module coupled to the gaming printer;
receiving by the voucher security module a voucher printed by the gaming printer; and
holding the voucher by the voucher security module if the gaming printer determines that the voucher is invalid whereby a player is prevented from obtaining the voucher.

7. An apparatus for securing a voucher by a gaming printer, comprising:
means for generating a voucher presentation signal; and
voucher security means coupled to the gaming printer for receiving the voucher and for presenting the voucher to a player in response to the voucher presentation signal whereby a player is prevented from obtaining the voucher until the gaming printer has completed printing the voucher.

8. The apparatus of claim 7, wherein the means for generating a voucher presentation signal further includes:
means for determining if the voucher is valid; and
means for generating the voucher presentation signal if the voucher is determined to be valid.

9. An apparatus for securing a voucher by a gaming printer, comprising:
means for determining if the voucher is valid;
means for generating a voucher retraction signal if the voucher is invalid; and
voucher security means coupled to the gaming printer for receiving the voucher and for retracting the voucher into the gaming printer in response to the voucher retraction signal whereby a player is prevented from obtaining the voucher.

10. The apparatus of claim 9, further comprising means for voiding the voucher.

11. An apparatus for securing a voucher by a gaming printer, comprising:
means for determining if the voucher is valid; and
voucher security means coupled to the gaming printer for receiving and holding the voucher if the voucher is invalid whereby a player is prevented from obtaining the voucher.

12. A voucher security module for attachment to a gaming printer, comprising:
a housing removably attached to the gaming printer;
a voucher guide secured within the housing, the voucher guide having a path length substantially the same as a length of a voucher printed by the gaming printer;
a roller assembly secured within the housing and substantially aligned with the voucher guide; and
a drive motor secured within the housing and coupled to the roller assembly whereby a voucher printed by the gaming printer is received by the voucher security module and held within the housing.

13. The voucher security module of claim 12 wherein the housing further includes a removable cover.
